(19) United States
(12) Patent Application Publication
(10) Pub. No.: US 2015/0284092 A1
(43) Pub. Date: Oct. 8, 2015

(54) EXTENDABLE LEG REST FOR AIRCRAFT PASSENGER SEAT

(71) Applicant: B/E Aerospace, Inc,, Wellington, FL (US)

(72) Inventors: Robert D. Wilkey, Atlanta, GA (US); Robert J. Henshaw, Newnan, GA (US); Joshua T. Munchow, Atlanta, GA (US)

(21) Appl. No.: 14/678,089

(22) Filed: Apr. 3, 2015

Related U.S. Application Data
(60) Provisional application No. 61/974,595, filed on Apr. 3, 2014.

(51) Int. Cl. B64D 11/06; B60N 2/44

(52) U.S. Cl. CPC B64D 11/0643; B60N 2/442

(57) ABSTRACT

An aircraft passenger seat including a seat bottom, a seatback pivotably attached to the seat bottom, and an extendable and angularly deployable leg rest pivotably attached to the seat bottom, the leg rest including leg rest rails pivotably attached to the seat bottom, a translating cushion assembly carried on the leg rest rails, a rack and pinion mechanism arranged to drive cushion assembly translation along the leg rest rails, and a timing link pivotably attached to the seat bottom arranged to actuate the rack and pinion mechanism in response to angular movement of the leg rest.

### CROSS-REFERENCE TO RELATED APPLICATION

This application claims priority from U.S. Application No. 61/974,595 filed Apr. 3, 2014, the entirety of which is incorporated by reference herein.

### TECHNICAL FIELD AND BACKGROUND OF THE INVENTION

The present invention relates generally to an extendable leg rest for use with an aircraft passenger seat, and more particularly, to a mechanism configured to extend the length of a deployable leg rest via a rack and pinion driven by the angular deployment of the leg rest.

Premium and business class aircraft passenger seats commonly include reclining seatbacks and deployable leg rests for achieving comfortable reclined sitting and horizontal sleeping positions. In fixed-shell aircraft seats in which the seatback reclines to a degree relative to a fixed-shell positioned behind the seatback, the leg rest typically deploys from a vertical position against the front of the seat to an elevated position at an angle to the floor. In lie-flat capable seats, the leg rest typically angularly deploys all the way to horizontal to form part of the bed.

In either seat type, it is not only desirable for the leg rest to adjust angularly, but also to extend lengthwise to accommodate passengers with long legs. While some leg rests move apart from the seat bottom as the leg rest deploys angularly, others are configured to extend and retract independent of the angular deployment of the leg rest. In either configuration, leg rest extension is typically accomplished using a pantograph mechanism. Pantograph mechanisms are undesirable because of their bulkiness, complexity, and weight, and must also be carefully designed to avoid pinch points. Pantograph mechanisms are also not easily reconfigurable to provide different extension ratios.

Therefore, what is needed is a compact leg rest extension design that avoids scissor linkages, is easily reconfigured to achieve different extension ratios, and improves the comfort and usability of the leg rest.

### BRIEF SUMMARY OF THE INVENTION

It is therefore an object of the invention to provide a leg rest that extends in length as the leg rest deploys angularly.

It is another object of the invention to provide a leg rest that moves apart from the seat bottom as the leg rest pivots in the direction of horizontal.

It is a further object of the invention to provide a leg rest having a locking gas spring arranged to compress upon the force of leg rest stowing and extend to assist leg rest deployment.

It is a further object of the invention to provide leg rest particularly suited for fixed-shell aircraft passenger seats wherein the leg rest deploys to an angle to the floor short of horizontal.

It is a further object of the invention to provide a leg rest configured to move with the seat bottom from an upright to a reclined sitting positions, and including timing linkage arranged to move a cushion portion of the leg rest apart from the seat bottom as the leg rest deploys angularly.

It is a further object of the invention to provide a deployable and extendable leg rest assembly easily adapted to achieve different extension ratios.

To achieve the foregoing and other objects and advantages, in one embodiment the present invention provides an aircraft passenger seat including a seat bottom, a seatback pivotably attached to the seat bottom, and an extendable and angularly deployable leg rest pivotably attached to the seat bottom. The leg rest includes leg rest rails pivotably attached to the seat bottom, a translating cushion assembly carried on the leg rest rails, a rack and pinion mechanism arranged to drive cushion assembly translation along the leg rest rails, and a timing link pivotably attached to the seat bottom arranged to actuate the rack and pinion mechanism in response to angular movement of the leg rest.

In another aspect, the angular deployment of the leg rest causes the timing link to actuate the rack and pinion mechanism to drive the cushion assembly away from the seat bottom to extend a length of the leg rest.

In another aspect, wherein the rack and pinion mechanism may include an outboard toothed rack fixed to the cushion assembly, an inboard toothed rack slidable along one of the leg rest rails and pivotably attached to one end of the timing link, and a pinion gear arranged between the outboard and inboard toothed racks such that rotation of the pinion gear moves the outboard and inboard toothed racks in opposite directions.

In another aspect, the timing link may be pivotably attached at one end to a horizontally oriented post positioned on one side of the inboard toothed rack.

In another aspect, the leg rest may include a locking gas spring arranged between the seat bottom and leg rest such that stowing the leg rest compresses the locking gas spring and deploying the leg rest lengthens the locking gas spring.

In another aspect, a pivot attachment point of the leg rest rails to the seat bottom may be spaced from a pivot attachment point of the timing link to the seat bottom.

In another aspect, the cushion assembly may include a cushion carried on top of spaced frame members and front and rear transverse beam tubes.

In another aspect, the aircraft passenger seat may be a fixed-shell seat including a fixed shell positioned behind the seatback, and the leg rest deploys angularly toward horizontal.

According to another embodiment, the present invention provides a fixed-shell aircraft passenger seat including an extendable and angularly deployable leg rest. The seat includes a seat bottom, a seatback pivotably attached to the seat bottom, a fixed-shell positioned behind the seatback, and a leg rest pivotably attached to the seat bottom. The leg rest includes leg rest rails pivotably attached to the seat bottom, a translating cushion assembly carried on the leg rest rails, a translation mechanism arranged to drive cushion assembly translation along the leg rest rails, and a timing link pivotably attached to the seat bottom arranged to actuate the translation mechanism in response to angular leg rest movement.

In another aspect, angular deployment of the leg rest causes the timing link to actuate the translation mechanism to drive the cushion assembly away from the seat bottom to extend a length of the leg rest.

In another aspect, the translation mechanism may be a rack and pinion mechanism including an outboard toothed rack fixed to the cushion assembly, an inboard toothed rack slidable along one of the leg rest rails and pivotably attached to one end of the timing link, and a pinion gear arranged between the outboard and inboard toothed racks such that rotation of the pinion gear moves the outboard and inboard toothed racks in opposite directions.

In another aspect, the leg rest may deploy angularly to an angle short of horizontal.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the present invention are better understood when the following detailed description of the invention is read with reference to the accompanying drawings, in which:

FIG. 1 is a side elevation view of a fixed-shell passenger seat including an extendable leg rest according to an embodiment of the invention;

FIG. 2 shows the seat of FIG. 1 with the leg rest in mid-position;

FIG. 3 shows the seat of FIG. 1 with the leg rest fully deployed and extended;

FIG. 4 is a detailed view of the underside of the seat shown in FIG. 1;

FIG. 5 is a detailed view of the underside of the seat shown in FIG. 2;

FIG. 6 is a detailed view of the underside of the seat shown in FIG. 3;

FIG. 7 is a perspective view of the underside of the leg rest showing the rack and pinion mechanism; and

FIG. 8 is a perspective view of a second embodiment of a leg rest extension mechanism including a belt and pulley arrangement.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

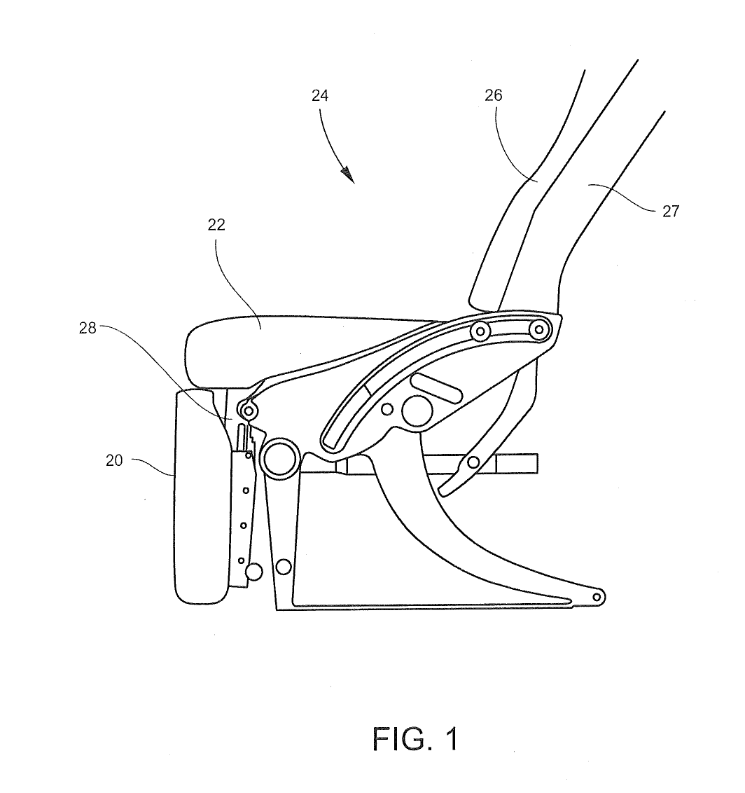

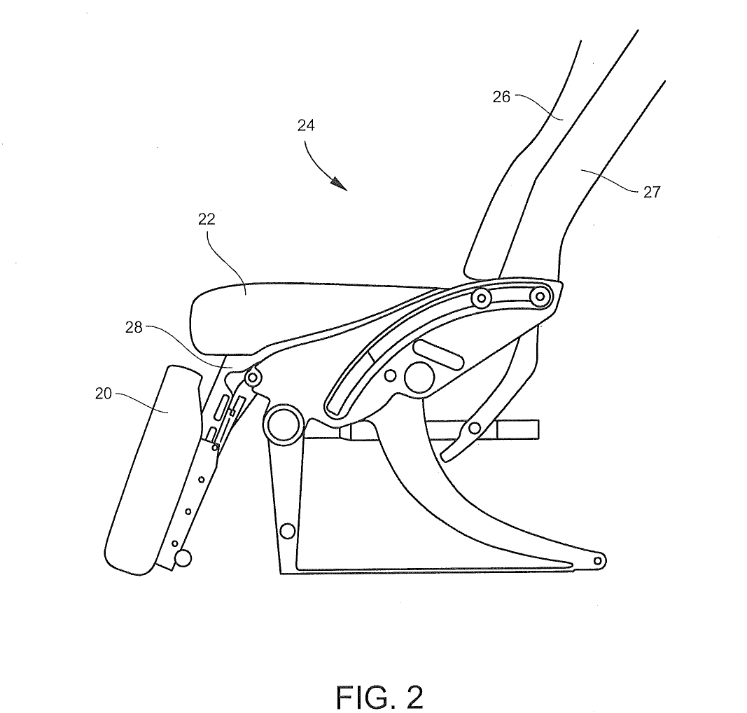

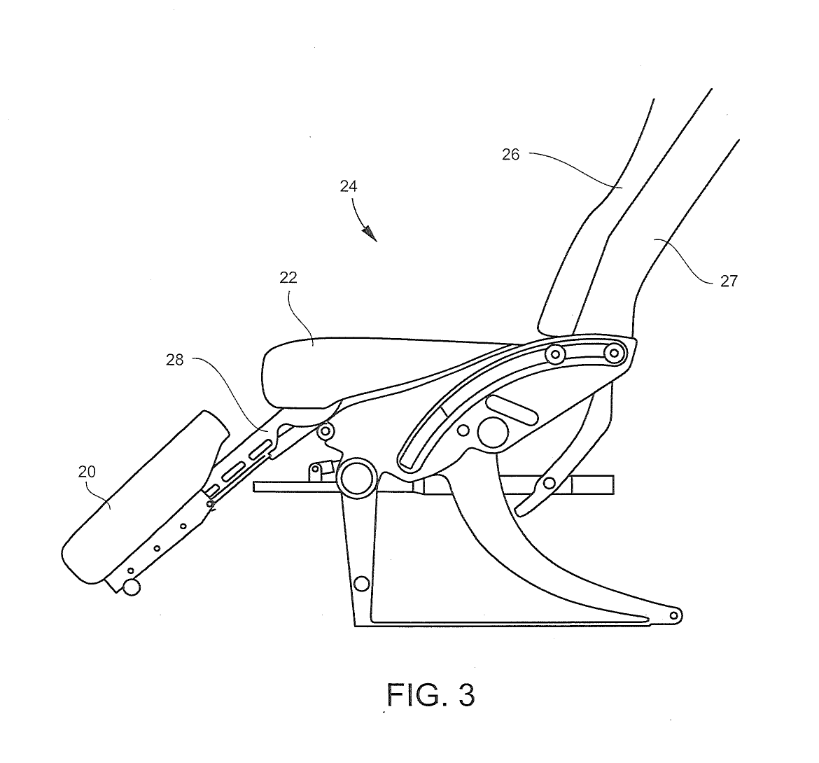

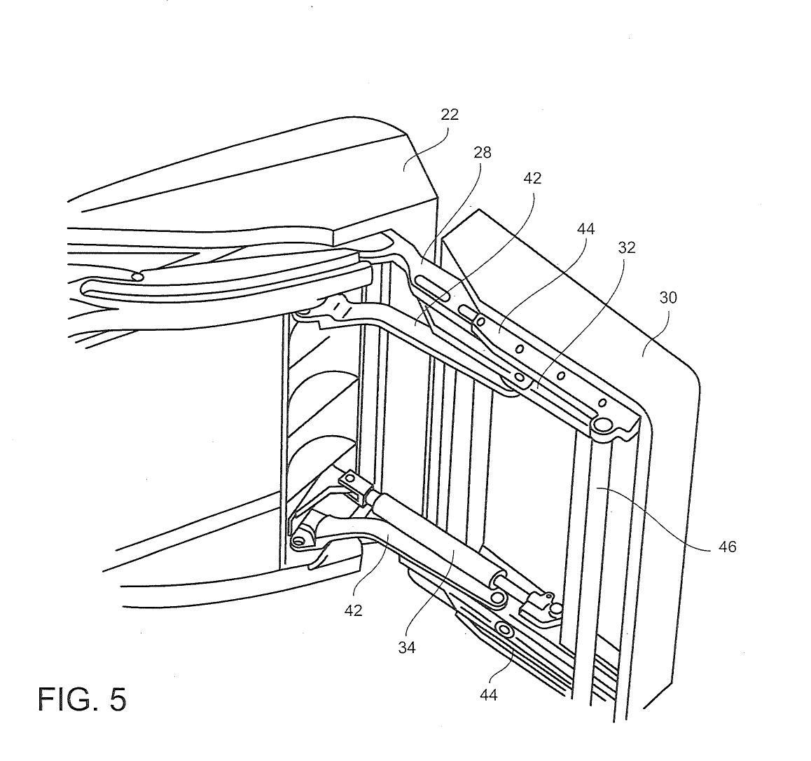

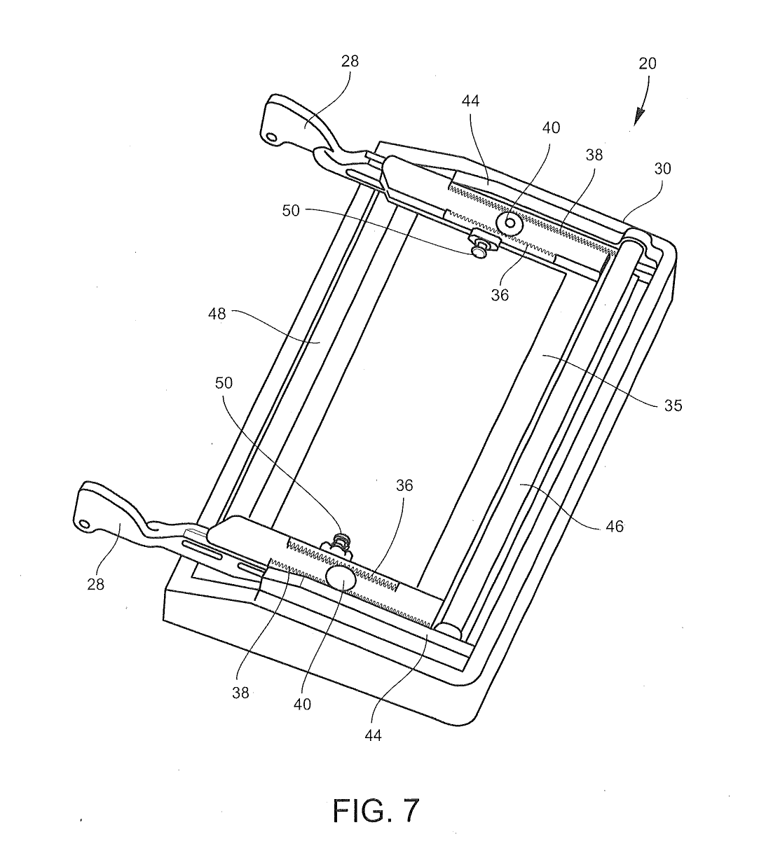

Referring to FIGS. 1-7, a first embodiment of an extendable leg rest is shown generally at reference numeral 20. Leg rest 20 is shown pivotably attached proximate the forward end of a seat bottom 22 of an aircraft passenger seat 24. Seat 24 as shown is a fixed-shell aircraft seat including a seatback 26 configured to recline within and relative to a fixed-shell 27 positioned behind the seatback 26. Seat bottom 22 may be moved to drive seatback movement between an upright sitting position for taxi, take-off and landing (TTOL) as shown in FIG. 1, and a fully reclined sitting position as shown in FIG. 3. The seat bottom 22 may translate forward and lower to the floor as the seat 24 adjusts from upright to reclined, thereby carrying the pivotably attached leg rest 20 along therewith.

The leg rest 20 is pivotably attached at one end to the seat bottom 22 such that the leg rest is configured to pivot between a first position stowed generally vertically against the front of the seat 24, and a second position at an angle to the floor, for example, about 30-45 degrees as shown in FIG. 3. The leg rest deploys angularly and preferably steplessly between its stowed and fully deployed positions such that the leg rest can be positioned at any desired angle along its range of motion. The leg rest 20 may deploy independent of seat recline or together with the seat recline movement. When employed on a fixed-shell aircraft passenger seat as shown, leg rest deployment may stop short of achieving horizontal as a result of the limited seatback recline and lack of living space dedicated for this particular seat. When employed on a lie-flat seat capable such as a seat found in an individual passenger suite, the leg rest preferably deploys to horizontal to help form part of the bed. The leg rest 20 can be attached to a variety of seat types that may or may not be configured to recline and may or may not include a movable seat bottom.

In either seat configuration, the leg rest 20 is configured to extend in length as it angularly deploys. In other words, the cushioned portion of the leg rest 20 moves farther apart from the seat bottom 22 the more the leg rest moves angularly toward horizontal. This lengthwise extension enhances comfort and usability of the leg rest, particularly for longer legged passengers.

The leg rest 20 is an assembly generally including parallel leg rest rails 28, or “rails”, that move (i.e., pivot) together with each rail pivotably attached at one end to the seat bottom 22, a cushion assembly 30 slidably carried on the leg rest rails 28, and a rack and pinion mechanism 32 arranged to drive the translation of the cushion assembly 30 along the length of the leg rest rails 28 as the leg rest 20 deploys angularly. The leg rest may further include a locking gas spring 34 arranged to angularly deploy the rails 28.

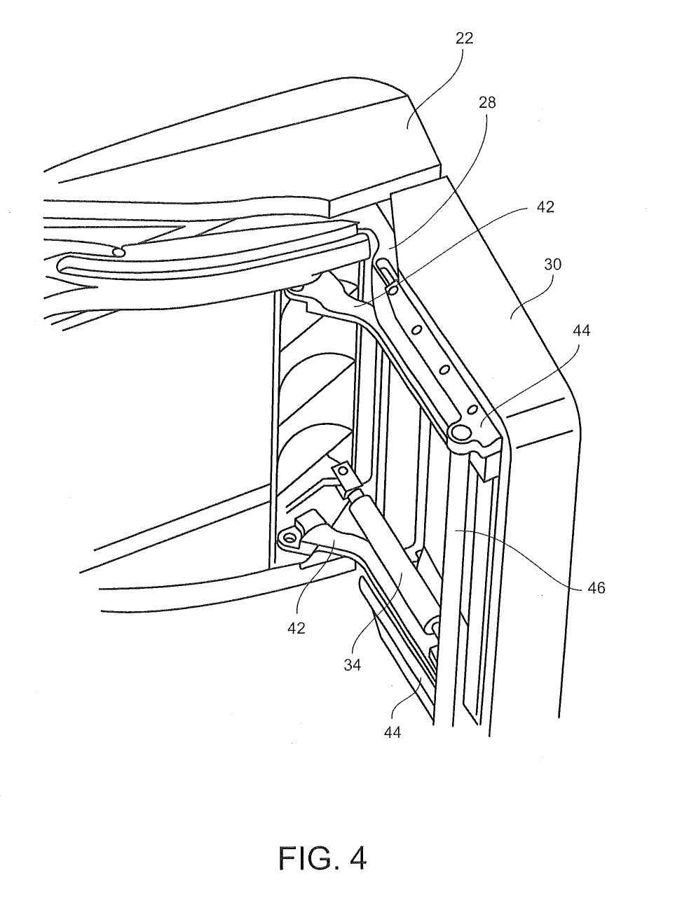

The rack and pinion mechanism 32 includes parallel arranged inboard and outboard toothed sliding racks 36, 38 meshed on diametrically opposing sides of a pinion gear 40 to drive the cushion 30 along the rails 28 as the leg rest deploys angularly. As best shown in FIGS. 4-6, spaced timing links 42 pivotably attached to the seat bottom 22 pivot about a pivot axis spaced from a pivot axis of the leg rest rails 28. As the leg rest 20 deploys angularly, the timing links 42 pull on the inboard set of sliding racks 36 to rotate the pinion gears 40 in one direction, thereby driving the outboard sliding racks 38 in the opposite direction of the pulling to move the cushion 30 apart from the seat bottom 22. In other words, the timing links 42 pull the inboard rails 36 toward the seat bottom 22 as the leg rest deploys angularly, thereby rotating the pinion gears 40 to drive the outboard sliding racks 38 in the opposite direction to drive the cushion 30 away from the seat bottom 22.

The outboard sliding racks 38 are fixed to the inboard sides of frame members 44 on the underside of the cushion 30 such that movement of the outboard sliding racks 38 moves the cushion 30. The cushion frame further includes spaced front and rear transverse beams 46, 48 arranged to keep the cushion square. The inboard sliding racks 36, one on each rail 28, slide along the length of their respective rail 28. The timing links 42 pivotably attach to a post 50 carried on the inboard side of each inboard sliding rack 36. The teeth on the inboard sliding racks 36 face the teeth on the outboard sliding racks 38 and the two sets of racks are maintained parallel and they slide in opposite directions.

As the leg rest 20 deploys angularly, the timing links 42 pull on the inboard sliding racks 36 to rotate the pinion gears 40 in one direction (i.e., clockwise) to drive leg rest extension (i.e., cushion movement in the direction away from the seat bottom 22). As the leg rest 20 stows angularly, the timing links 42 push on the inboard sliding racks 36 to rotate the pinion gears 40 in the opposite direction (i.e., counterclockwise) to retract the leg rest (i.e., cushion movement in the direction toward the seat bottom 22). Leg rest movement can be considered telescopic in that the cushion overlaps and translates relative to the underlying support structure.

The teeth on the respective racks 36, 38 and pinion gears 40 can be changed to customize the extension ratio of the cushion to provide for greater or lesser extension in certain applications. The extension ratio can also be adjusted by changing the length on the timing links 42 and/or position of their respective pivot axis relative to the pivot axis of the rails 28.

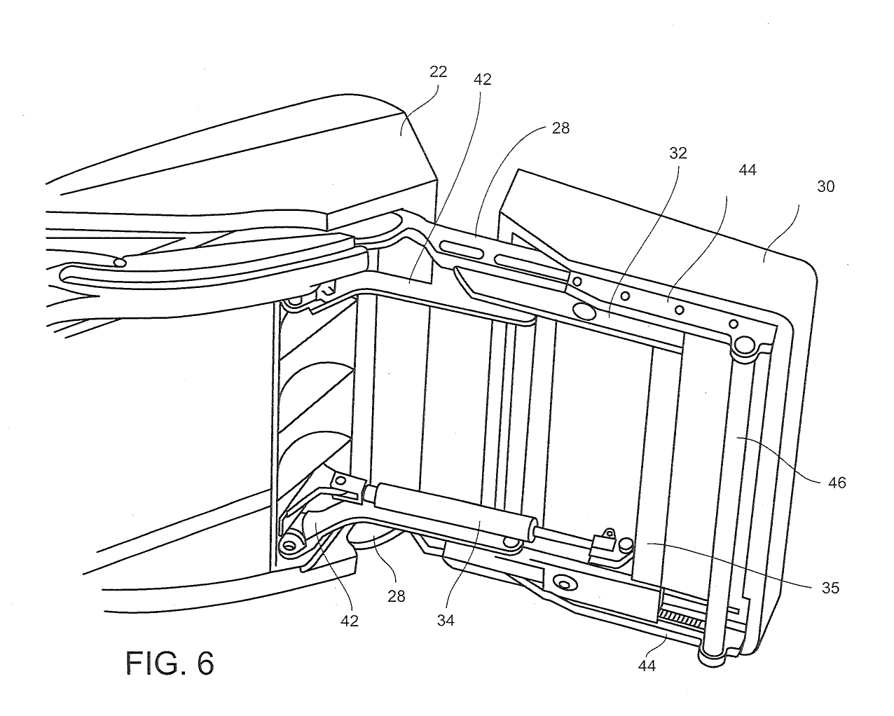

As best shown in FIGS. 4-6, the locking gas spring 34 is arranged between the seat bottom 22 and the rails 28 to drive the angular deployment of the leg rest 20. Specifically, the locking gas spring 34 is attached to the seat bottom 22 and a transverse member 35 interconnecting the ends of the leg rest rails 28. When the leg rest 20 is stowed as shown in FIG. 4, the locking gas spring 34 is compressed and “charged” (i.e., the piston is compressed into the cylinder). When the leg rest 20 is deployed as shown in FIG. 6, the gas spring 34 is extended. The leg rest 20 can be stowed by pushing down on the leg rest in the direction of the stowed position to charge the gas spring 34, and released by actuating a release switch.

Rack and pinion mechanisms may be provided on one side of the leg rest 20, or on both sides to maintain parallelness. In an alternative embodiment, the pinion gears 40 may be replaced with a pair of joined pinions of differing ratios to achieve greater extension ratios.

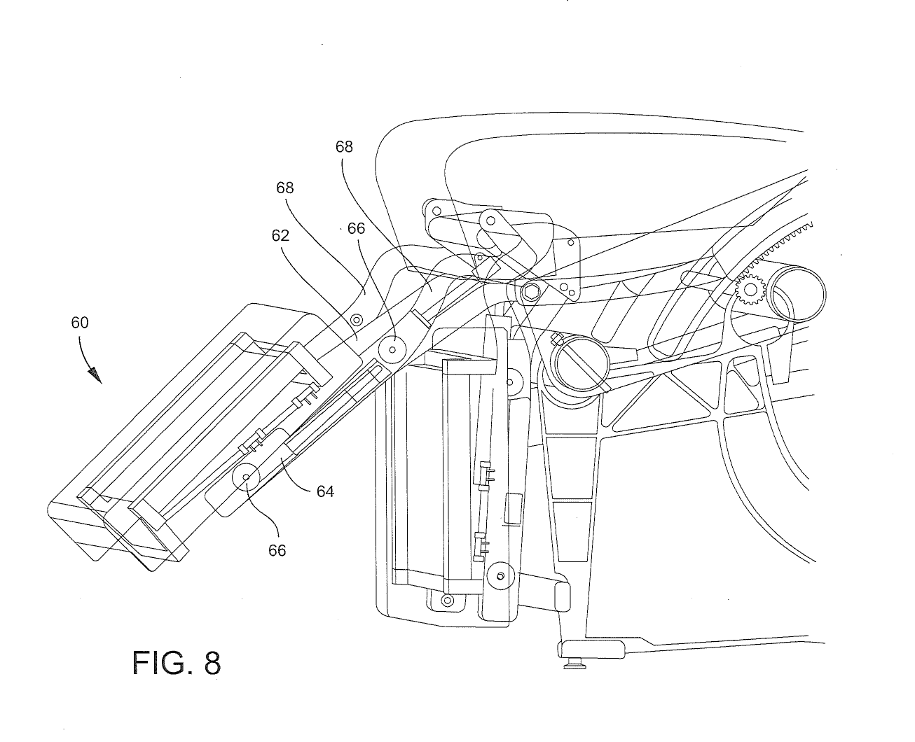

Referring to FIG. 8, a second embodiment of an extendable leg rest is shown generally at reference numeral 60. This second embodiment employs a belt and pulley arrangement in place of the rack and pinion mechanism of the first embodiment. Specifically, timing linkage 62 may be used to drive a toothed cog belt 64 arranged on vertically oriented pulleys 66 rotatably carried on pivoting leg rest rails 68. As the rails 68 deploy angularly, the timing linkage 62 drives belt rotation, thereby driving cushion movement.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. An aircraft passenger seat, comprising:
a seat bottom;
a seatback pivotably attached to the seat bottom; and
an extendable and angularly deployable leg rest pivotably attached to the seat bottom, the leg rest comprising:
(i) leg rest rails pivotably attached to the seat bottom;
(ii) a translating cushion assembly carried on the leg rest rails;
(iii) a rack and pinion mechanism arranged to drive cushion assembly translation along the leg rest rails; and
(iv) a timing link pivotably attached to the seat bottom arranged to actuate the rack and pinion mechanism in response to angular movement of the leg rest.

2. The aircraft passenger seat of claim 1, wherein angular deployment of the leg rest causes the timing link to actuate the rack and pinion mechanism to drive the cushion assembly away from the seat bottom to extend a length of the leg rest.

3. The aircraft passenger seat of claim 1, wherein the rack and pinion mechanism comprises:
an outboard toothed rack fixed to the cushion assembly;
an inboard toothed rack slidable along one of the leg rest rails and pivotably attached to one end of the timing link; and
a pinion gear arranged between the outboard and inboard toothed racks such that rotation of the pinion gear moves the outboard and inboard toothed racks in opposite directions.

4. The aircraft passenger seat of claim 3, wherein the timing link is pivotably attached at one end to a horizontally oriented post positioned on one side of the inboard toothed rack.

5. The aircraft passenger seat of claim 1, further comprising a locking gas spring arranged between the seat bottom and leg rest such that stowing the leg rest compresses the locking gas spring and deploying the leg rest lengthens the locking gas spring.

6. The aircraft passenger seat of claim 1, wherein a pivot attachment point of the leg rest rails to the seat bottom is spaced from a pivot attachment point of the timing link to the seat bottom.

7. The aircraft passenger seat of claim 1, wherein the cushion assembly includes a cushion carried on top of spaced frame members and front and rear transverse beam tubes.

8. The aircraft passenger seat of claim 1, wherein the aircraft passenger seat is a fixed-shell seat including a fixed shell positioned behind the seatback, and the leg rest deploys angularly toward horizontal.

9. A fixed-shell aircraft passenger seat including an extendable and angularly deployable leg rest, comprising:
a seat bottom;
a seatback pivotably attached to the seat bottom;
a fixed-shell positioned behind the seatback; and
a leg rest pivotably attached to the seat bottom, comprising:
(i) leg rest rails pivotably attached to the seat bottom;
(ii) a translating cushion assembly carried on the leg rest rails;
(iii) a translation mechanism arranged to drive cushion assembly translation along the leg rest rails; and
(iv) a timing link pivotably attached to the seat bottom arranged to actuate the translation mechanism in response to angular leg rest movement.

10. The aircraft passenger seat of claim 9, wherein angular deployment of the leg rest causes the timing link to actuate the translation mechanism to drive the cushion assembly away from the seat bottom to extend a length of the leg rest.

11. The aircraft passenger seat of claim 9, wherein the translation mechanism is a rack and pinion mechanism, comprising:
an outboard toothed rack fixed to the cushion assembly;
an inboard toothed rack slidable along one of the leg rest rails and pivotably attached to one end of the timing link; and
a pinion gear arranged between the outboard and inboard toothed racks such that rotation of the pinion gear moves the outboard and inboard toothed racks in opposite directions.

12. The aircraft passenger seat of claim 11, wherein the timing link is pivotably attached at one end to a horizontally oriented post positioned on one side of the inboard toothed rack.

13. The aircraft passenger seat of claim 9, further comprising a locking gas spring arranged between the seat bottom and leg rest such that stowing the leg rest compresses the locking gas spring and deploying the leg rest lengthens the locking gas spring.

14. The aircraft passenger seat of claim 9, wherein a pivot attachment point of the leg rest rails to the seat bottom is spaced from a pivot attachment point of the timing link to the seat bottom.

15. The aircraft passenger seat of claim 9, wherein the cushion assembly includes a cushion carried on top of spaced frame members and front and rear transverse beam tubes.

16. The aircraft passenger seat of claim 9, wherein the leg rest deploys angularly to an angle short of horizontal.
